(19) United States
(12) Patent Application Publication
(10) Pub. No.: US 2024/0127310 A1
(43) Pub. Date: Apr. 18, 2024

(54) SYSTEMS AND METHODS FOR USING BOUNDING BOX GEOSEARCHING TO IDENTIFY SERVICE PROVIDERS

(71) Applicant: Aetna Inc., Hartford, CT (US)

(72) Inventors: Aaron Zavora, Hartford, CT (US); Megan Heusey, Hartford, CT (US); Akshita Jaitly, Hartford, CT (US); Harsha Kandula, Hartford, CT (US)

(21) Appl. No.: 17/967,517

(22) Filed: Oct. 17, 2022

(51) Int. Cl. G06Q 30/06; H04W 4/02

(52) U.S. Cl. CPC G06Q 30/0631; H04W 4/023

(57) ABSTRACT

In some instances, a method for identifying one or more service providers is provided. The method comprises obtaining, by a user device, a geographic location associated with a user; determining, by the user device and based on the geographic location, a bounding area indicating a search region extending from the geographic location, wherein the bounding area corresponds to a plurality of boundary points; determining, by the user device and based on the plurality of boundary points, a plurality of geohash strings for the plurality of boundary points; determining, by the user device, one or more service providers based on the plurality of geohash strings; and causing, by the user device, display of the one or more service providers.

### BACKGROUND

Users searching for health goods or services may use devices and/or systems to assist them with finding a service provider that provides the relevant goods or services. For instance, a user may use a device to look up which service providers provide the relevant goods or services, and which service providers are accessible or close to the user. However, traditional approaches to locating a relevant service provider can experience large delays in processing times that increase proportionally with number of service providers queried. Moreover, traditional approaches may fail to accurately locate a relevant service provider, even after the query has been processed. Accordingly, there remains a technical need to provide a system that provides an efficient, scalable, and accurate approach to locating a relevant service provider that is accessible to the user.

### SUMMARY

In some examples, the present application provides a system and method to locate service providers within a defined geographic area using bounding box geohashing. By using bounding box geohashing, the system and method may efficiently and accurately identify a set of service providers, and may retain this efficiency and accuracy as the total number of service providers in an environment increases (e.g., may be scalable). For example, the present application may obtain a geographic location of the user such as an address associated with the user. Then, the present application may determine a bounding area indicating a search region that extends from the geographic location, and determine boundary points for the bounding area (e.g., the four corner points that define the bounding area). Subsequently, the present application may determine geohash strings for the boundary points, and determine service providers within the geohash strings. The present application may output or display one or more of the service providers within the geohash string (e.g., the closest service provider to the user). By using the system and method of the present application, this may save computing resources and computing time, and increases accuracy by focusing computing resources on the smaller set of service providers that is the most geographically relevant for the user, while also obtaining the smaller set of service providers from the total number of service providers in a faster and less resource intensive manner. This will be described in further detail below.

In one aspect, a method for identifying one or more service providers is provided. The method comprises: obtaining, by a user device, a geographic location associated with a user; determining, by the user device and based on the geographic location, a bounding area indicating a search region extending from the geographic location, wherein the bounding area corresponds to a plurality of boundary points; determining, by the user device and based on the plurality of boundary points, a plurality of geohash strings for the plurality of boundary points; determining, by the user device, one or more service providers based on the plurality of geohash strings; and causing, by the user device, display of the one or more service providers.

Examples may include one of the following features, or any combination thereof. For instance, in some examples, obtaining the geographic location comprises: transmitting, by the user device and to an enterprise computing system, a request for an address of the user; and receiving, by the user device and from the enterprise computing system, the address of the user, wherein the address indicates the geographic location of the user.

In some variations, obtaining the geographic location comprises: determining, by the user device, latitude and longitude coordinates of the user device using global positioning services (GPS); and determining the geographic location of the user based on the latitude and longitude coordinates.

In some instances, determining the bounding area further comprises: retrieving, by the user device, a predetermined distance from a memory of the user device; and determining the bounding area indicating the search region based on the predetermined distance.

In some examples, determining the one or more service providers comprises: determining a plurality of service providers associated with the plurality of geohash strings for the plurality of boundary points; and filtering the plurality of service providers to determine the one or more service providers based on the bounding area indicated by the search region.

In some variations, the method further comprises: obtaining, by the user device, a user input indicating a distance for the search region; and determining the bounding area indicating the search region comprises: determining the plurality of boundary points based on the distance indicated by the user input, wherein the plurality of boundary points are four corner points of the bounding area.

In some instances, determining the one or more service providers comprises: determining a plurality of service providers associated with the plurality of geohash strings for the plurality of boundary points; and filtering the plurality of service providers to determine the one or more service providers based on the distance indicated by the user input.

In some examples, determining the plurality of service providers associated with the plurality of geohash strings for the plurality of boundary points comprises: determining, based on the plurality of geohash strings, a common geohash identifier; and determining a service provider from the plurality of service providers associated with the common geohash identifier.

In some variations, the common geohash identifier and the plurality of geohash identifiers are bit strings, and the common geohash identifier has fewer bits than each of the plurality of geohash strings.

In some instances, filtering the plurality of service providers further comprises: determining a plurality of service provider distances, wherein each of the plurality of service provider distances indicates a distance between a service provider, from the plurality of service providers, and the geographic location; and determining the one or more service providers based on comparing the plurality of service provider distances with the distance indicated by the user input.

In some examples, the method further comprises: determining a circular area associated with the distance indicated by the user input; and filtering the plurality of service providers to determine the one or more service providers based on the circular area.

In some variations, causing display of the one or more service providers comprises causing display of a geographic region indicated by the circular area and geographic locations of the one or more service providers within the circular area.

In another aspect, a user device comprising one or more processors and non-transitory computer-readable medium having processor-executable instructions stored thereon is provided. The processor-executable instructions, when executed by the one or more processors, facilitate: obtaining a geographic location associated with a user; determining, based on the geographic location, a bounding area indicating a search region extending from the geographic location, wherein the bounding area corresponds to a plurality of boundary points; determining, based on the plurality of boundary points, a plurality of geohash strings for the plurality of boundary points; determining one or more service providers based on the plurality of geohash strings; and causing display of the one or more service providers.

Examples may include one of the following features, or any combination thereof. For instance, in some examples, the processor is further configured to obtain the geographic location by: transmitting, to an enterprise computing system, a request for an address of the user; and receiving, from the enterprise computing system, the address of the user, wherein the address indicates the geographic location of the user.

In some variations, the processor is further configured to obtain the geographic location by: determining latitude and longitude coordinates of the user device using GPS; and determining the geographic location of the user based on the latitude and longitude coordinates.

In some instances, the processor is further configured to determine the bounding area by: retrieving a predetermined distance from a memory of the user device; and determining the bounding area indicating the search region based on the predetermined distance.

In some examples, the processor is further configured to determine the one or more service providers by: determining a plurality of service providers associated with the plurality of geohash strings for the plurality of boundary points; and filtering the plurality of service providers to determine the one or more service providers based on the bounding area indicated by the search region.

In some variations, the processor is further configured to: obtain a user input indicating a distance for the search region; and the processor is further configured to determine the bounding area indicating the search region by: determining the plurality of boundary points based on the distance indicated by the user input, wherein the plurality of boundary points are four corner points of the bounding area.

In some instances, the processor is further configured to determine the one or more service providers by: determining a plurality of service providers associated with the plurality of geohash strings for the plurality of boundary points; and filtering the plurality of service providers to determine the one or more service providers based on the distance indicated by the user input.

In yet another aspect, a non-transitory computer-readable medium having processor-executable instructions stored thereon is provided. The processor-executable instructions, when executed, facilitate: obtaining a geographic location associated with a user; determining, based on the geographic location, a bounding area indicating a search region extending from the geographic location, wherein the bounding area corresponds to a plurality of boundary points; determining, based on the plurality of boundary points, a plurality of geohash strings for the plurality of boundary points; determining one or more service providers based on the plurality of geohash strings; and causing display of the one or more service providers.

All examples and features mentioned above may be combined in any technically possible way.

### BRIEF DESCRIPTION OF THE DRAWINGS

The subject technology will be described in even greater detail below based on the exemplary figures, but is not limited to the examples. All features described and/or illustrated herein can be used alone or combined in different combinations. The features and advantages of various examples will become apparent by reading the following detailed description with reference to the attached drawings which illustrate the following:

FIG. 1 is a simplified block diagram depicting an exemplary computing environment in accordance with one or more examples of the present application.

FIG. 2 is a simplified block diagram of one or more devices or systems within the exemplary environment of FIG. 1.

FIG. 3 shows an exemplary process for using bounding box geohashing for locating service providers in accordance with one or more examples of the present application.

FIG. 4 is another exemplary process for using bounding box geohashing for locating service providers in accordance with one or more examples of the present application.

FIGS. 5A-5C show a depiction of using bounding box geohashing to locate a service provider in accordance with one or more examples of the present application.

### DETAILED DESCRIPTION

Examples of the present application will now be described more fully hereinafter with reference to the accompanying FIGS, in which some, but not all, examples of the application are shown. Indeed, the application may be exemplified in different forms and should not be construed as limited to the examples set forth herein; rather, these examples are provided so that the application will satisfy applicable legal requirements. Where possible, any terms expressed in the singular form herein are meant to also include the plural form and vice versa, unless explicitly stated otherwise. Also, as used herein, the term “a” and/or “an” shall mean “one or more” even though the phrase “one or more” is also used herein. Furthermore, when it is said herein that something is “based on” something else, it may be based on one or more other things as well. In other words, unless expressly indicated otherwise, as used herein “based on” means “based at least in part on” or “based at least partially on.”

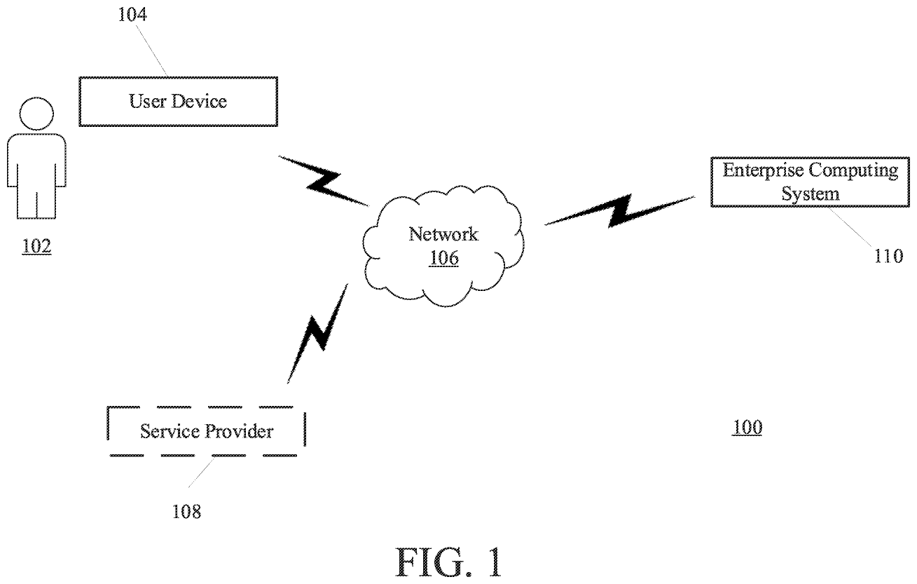

Systems, methods, and computer program products are herein disclosed that provide for using devices and geolocation information to locate service providers for a user. FIG. 1 is a simplified block diagram depicting an exemplary environment in accordance with an example of the present application. The environment 100 includes a user (e.g., an individual or a member) 102, a user device (e.g., mobile device) 104 associated with the user 102, a network 106, and an enterprise computing system (e.g., back-end server) 110. Additionally, in some instances, the environment 100 may further include one or more service providers (e.g., a skilled nursing facility) 108. The dashed box for the service provider 108 indicates that the service provider 108 is optional. When present, the service provider 108 may be in communication with one or more entities of environment 100 using the network 106. Although the entities within environment 100 may be described below and/or depicted in the FIGS. as being singular entities, it will be appreciated that the entities and functionalities discussed herein may be implemented by and/or include one or more entities.

The entities within the environment 100 such as the user device 104, the service provider 108, and/or the enterprise computing system 110 may be in communication with other devices/systems within the environment 100 via the network 106. The network 106 may be a global area network (GAN) such as the Internet, a wide area network (WAN), a local area network (LAN), or any other type of network or combination of networks. The network 106 may provide a wireline, wireless, or a combination of wireline and wireless communication between the entities within the environment 100.

User 102 may operate, own, and/or otherwise be associated with a user device 104. For instance, the user device 104 may be a mobile phone such as a smartphone that is owned and/or operated by the user 102. The user 102 may use the user device 104 to provide information to the other entities of environment 100 (e.g., the enterprise computing system 110) and/or receive information from the other entities of the environment 100. For example, the user device 104 may receive user input from the individual (e.g., user 102) such as indications to download, operate, and/or manage a software application associated with an enterprise organization. The enterprise organization may be any type of corporation, company, organization, and/or other institution that owns, develops, manages, and/or is associated with the software application. In some instances, the enterprise organization may own, operate, and/or be otherwise associated with one or more service providers such as the service provider 108 that sell products/items and/or provide services. For instance, the service provider 108 may be and/or include, but is not limited to, a storefront that sells goods or a facility that provides medical services (e.g., hospital, clinic, or nursing facility such as a skilled nursing facility).

In operation, the user device 104 may determine locations of the service providers associated with the enterprise organization and provide the locations of the service providers to the user 102 (e.g., provide the location of the closest service provider to the user 102). For instance, the user 102 may require medical assistance and may seek to identify the closest medical service provider (e.g., a hospital). The user device 104 may be configured to determine locations of the service providers within the vicinity of the user 102, and determine the distances to each of the service providers. The user device 104 may be configured to display the closest service provider to the user 102.

In some instances, the user device 104 may use bounding box geohashing to identify and/or display the locations of one or more service providers such as the service provider 108. For instance, traditionally, geohashing has been used for location services. Geohashing may be used to convert addresses into a geographic coordinate (e.g., latitude and longitude) and then encode the geographic coordinates into a string that delineates an area on a map. For example, in some variations, geohashing may use a base 32 numeral system that encodes geographic locations. Each character added onto the string reduces the size of the area. For instance, the entire earth may be divided off into sections or regions using base 32 into a “0” to “z” textual representation. Then, each area defined by one of these sections may further be sub-divided using a second character of the string from “0” to “z”. This may continue onwards to reduce the sections into smaller and smaller geographical areas. Conventionally, location searching using a string identifying a geohashing region (e.g., a string “dnr6”) has been implemented to increase the scalability of the location searching and reduce computational resources necessary to identify the locations within the geohashing region. However, conventional methods and processes for using geohashing have proven inaccurate in certain situations.

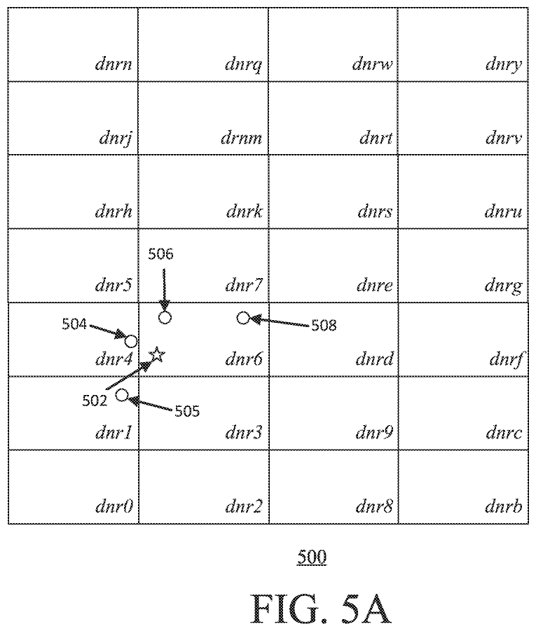

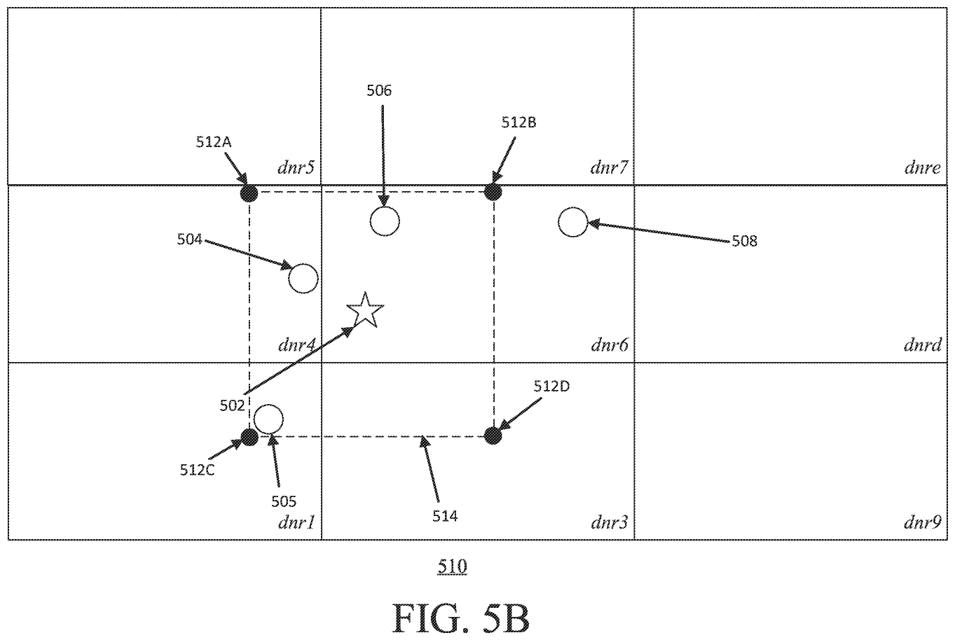

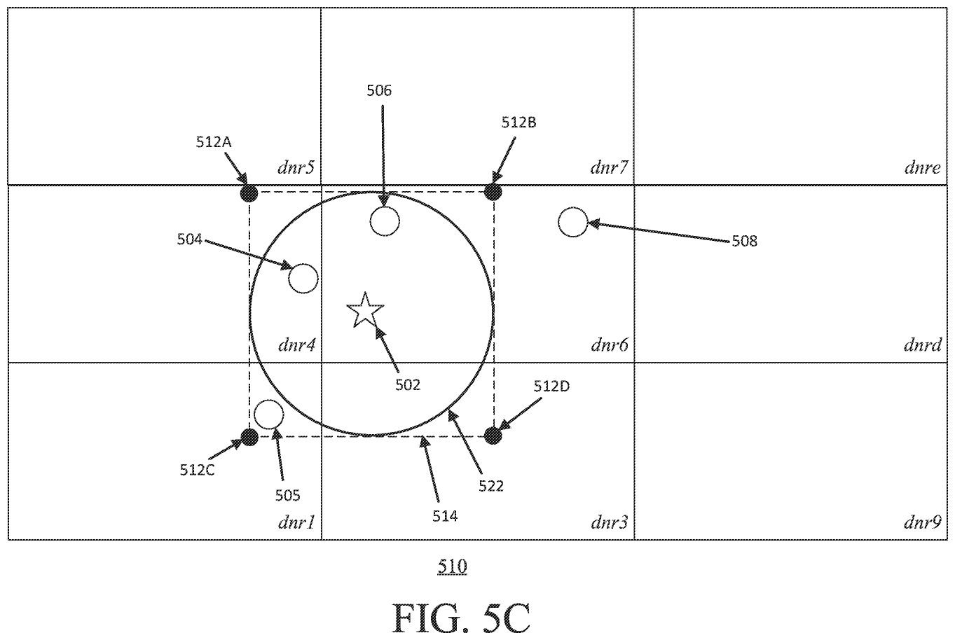

For instance, FIGS. 5A-5C show a depiction of using bounding box geohashing to locate a service provider in accordance with one or more examples of the present application. Referring to FIG. 5A, an area 500 is shown denoting different regions that are defined by a plurality of strings with the “dnr” geohashing identifiers (e.g., “dnrn” to “dnrb”). The user 102 may be associated with a location 502. For instance, the location 502 may be a location indicated by a user's address that is stored within the enterprise computing system 110 and/or may be a location of the user 102 currently. By using conventional methods and processes, the user device 104 may determine the geohashing location of the user as “dnr6” and identify service providers within the geohashing location. For instance, the user device 104, executing the software application associated with the enterprise organization, may identify the service providers 506 and 508 within the geohashing string of “dnr6.” However, as shown, neither service providers 506 nor 508 are the closest service provider to the location 502 of the user 102. Instead, the closest service provider to the location 502 of the user 102 is the service provider 504, which is in a different geohashing region, “dnr4.” Accordingly, as will be explained below, the user device 104 may use bounding box geohashing to determine the closest service provider to the user 102.

The user device 104 may be and/or include, but is not limited to, a desktop, laptop, tablet, mobile device (e.g., smartphone device, or other mobile device), smart watch, an internet of things (IOT) device, or any other type of computing device that generally comprises one or more communication components, one or more processing components, and one or more memory components. The user device 104 may be able to execute software applications managed, operated, and/or otherwise associated with the enterprise organization.

The enterprise computing system 110 is a computing system that is associated with the enterprise organization. The enterprise computing system 110 includes one or more computing devices, computing platforms, systems, servers, and/or other apparatuses capable of performing tasks, functions, and/or other actions for the enterprise organization. In some instances, the enterprise computing system 110 may, for example, receive and/or provide information from the user device 104 and/or the service provider 108. For instance, the enterprise computing system 110 may provide a software application to the user device 104 based on a request from the user device 104. Additionally, and/or alternatively, the enterprise computing system 110 may communicate with the user device 104 and/or the service provider 108. For instance, the enterprise computing system 110 may provide information that the user device 104 uses to determine the locations of the one or more service providers.

The enterprise computing system 110 may be implemented using one or more computing platforms, devices, servers, and/or apparatuses. In some variations, the enterprise computing system 110 may be implemented as engines, software functions, and/or applications. In other words, the functionalities of the enterprise computing system 110 may be implemented as software instructions stored in storage (e.g., memory) and executed by one or more processors.

The service provider 108 may be optionally included in the environment 100. The user device 104 may request information from the service provider 108, and the service provider 108 may provide information to the user device 104 (e.g., the services provided by the service provider 108, the location of the service provider 108). In some instances, the service provider 108 may provide this information to the user device 104 without the user device 104 providing the request.

It will be appreciated that the exemplary environment depicted in FIG. 1 is merely an example, and that the principles discussed herein may also be applicable to other situations—for example, including other types of institutions, organizations, devices, systems, and network configurations. As will be described herein, the environment 100 may be used by health care enterprise organizations. However, in other instances, the environment 100 may be used by other types of enterprise organizations such as financial institutions or insurance institutions.

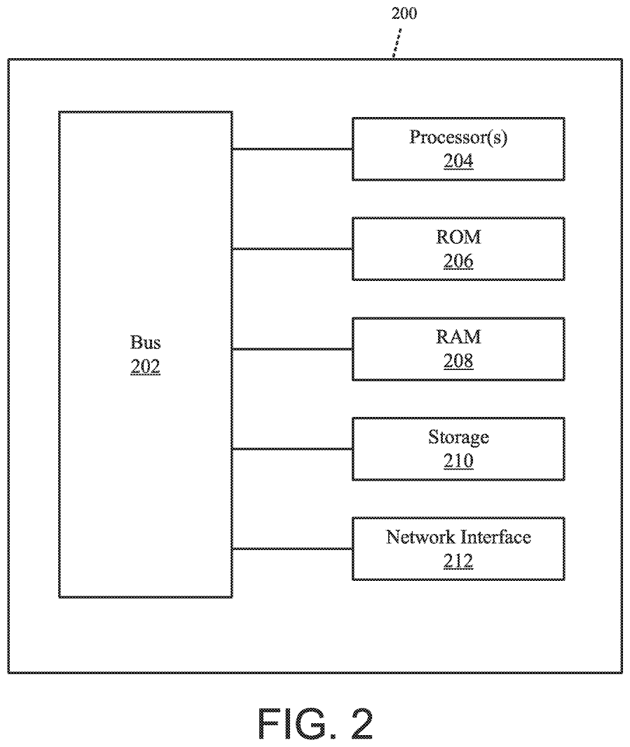

FIG. 2 is a block diagram of an exemplary system and/or device 200 within the environment 100. The device/system 200 includes a processor 204, such as a central processing unit (CPU), controller, and/or logic, that executes computer executable instructions for performing the functions, processes, and/or methods described herein. In some examples, the computer executable instructions are locally stored and accessed from a non-transitory computer readable medium, such as storage 210, which may be a hard drive or flash drive. Read Only Memory (ROM) 206 includes computer executable instructions for initializing the processor 204, while the random-access memory (RAM) 208 is the main memory for loading and processing instructions executed by the processor 204. The network interface 212 may connect to a wired network or cellular network and to a local area network or wide area network, such as the network 106. The device/system 200 may also include a bus 202 that connects the processor 204, ROM 206, RAM 208, storage 210, and/or the network interface 212. The components within the device/system 200 may use the bus 202 to communicate with each other. The components within the device/system 200 are merely exemplary and might not be inclusive of every component, server, device, computing platform, and/or computing apparatus within the device/system 200. Additionally, and/or alternatively, the device/system 200 may further include components that might not be included within every entity of environment 100.

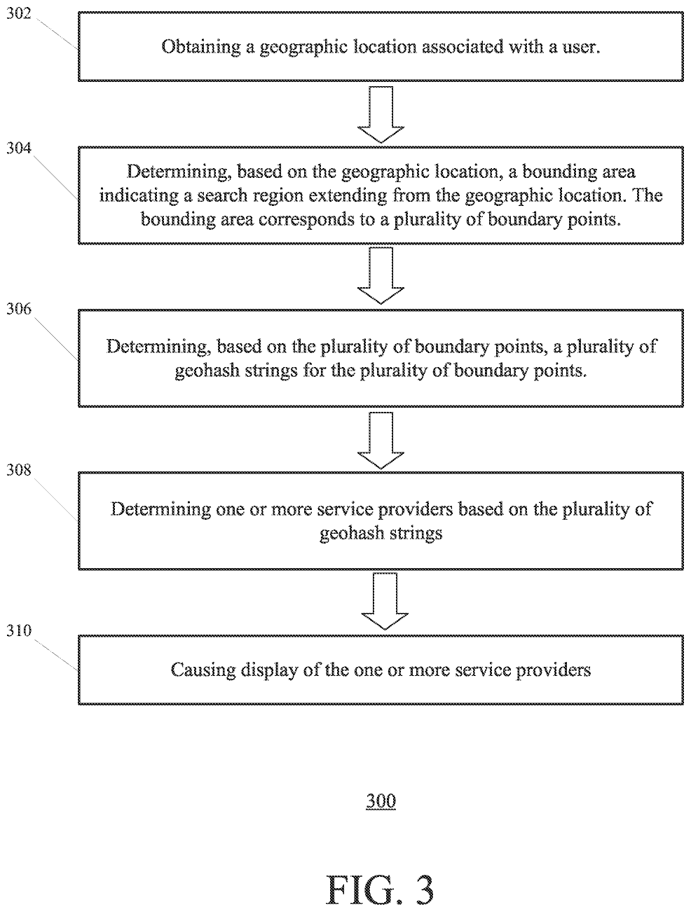

FIG. 3 shows an exemplary process 300 for using bounding box geohashing for locating service providers in accordance with one or more examples of the present application. The process 300 may be performed by the user device 104 of FIG. 1. However, it will be recognized that any of the following blocks may be performed in any suitable order and that the process 300 may be performed in any suitable environment and by any suitable device. For instance, the enterprise computing system 110 may perform the process 300 based on a request from the user device 104. The descriptions, illustrations, and processes of FIG. 3 are merely exemplary and the process 300 may use other descriptions, illustrations, and processes for using bounding box geohashing for locating service providers.

At block 302, the user device 104 obtains a geographic location associated with a user 102. For example, the enterprise computing system 110 may obtain and/or store information of the user 102 including an address (e.g., a home address and/or business address) of the user 102. For instance, the enterprise organization may be a medical service provider that provides medical services and/or an insurance company. The user 102 may be associated with the enterprise organization such as by receiving insurance from the enterprise organization. Therefore, the enterprise computing system 110 may obtain an address of the user 102 and may provide the address of the user 102 to the user device 104. The user device 104 may determine the geographic location of the user 102 as the address of the user 102 that is provided from the enterprise computing system 110.

In some instances, the user device 104 may obtain the address of the user 102 without communicating with the enterprise computing system 110. For instance, the user device 104 may display a display screen to the user 102. The user 102 may provide user input indicating a current location or a physical address of the user 102 using the display screen (e.g., a street, state, zip code, latitude and longitude coordinates, and/or other types of location identifiers indicating the location of the user 102) of the user device 104. The user device 104 may obtain (e.g., determine) the geographic location of the user 102 based on the user input. Additionally, and/or alternatively, the user device 104 may include geo-location services (e.g., a global positioning system (GPS)) to determine the geographic location of the user 102. For instance, the user device 104 may determine the geographic location of the user 102 (e.g., street address, geographic coordinates, and/or latitude and longitude coordinates) using the geo-location services.

At block 304, the user device 104 determines, based on the geographic location, a bounding area indicating a search region extending from the geographic location. The bounding area corresponds to a plurality of boundary points. The user device 104 may determine the bounding area as an area that surrounds the geographic location of the user 102 that was obtained at block 302. The bounding area may be an area defined by a plurality of boundary points (e.g., a square or rectangular area that is defined by four boundary points).

In some instances, the bounding area is centered by the geographic location obtained at block 302. In other instances, the bounding area is not centered by this geographic location.

In some examples, the user device 104 determines the bounding area based on a predetermined or fixed distance (e.g., a fixed five or ten mile distance from the geographic location). For instance, the user device 104 may retrieve a predetermined distance from memory and use the predetermined distance (e.g., five miles) to determine the bounding area. In other examples, the user device 104 may obtain user input indicating a distance for the bounding area. For instance, the user device 104 may display a display screen that the user 102 can use to specify a distance for the bounding area (e.g., a maximum distance to search for a service provider). Based on the fixed distance and/or the user input indicating the distance as well as the geographic location associated with the user 102, the user device 104 may determine the bounding area indicating the search region.

In some variations, the user device 104 determines the bounding area based on a predetermined or fixed area (e.g., a twenty-five or hundred square mile area). For instance, the user device 104 may retrieve a predetermined area from memory and determine a distance from the predetermined area (e.g., maximum and/or minimum distance from user 102, shape of fixed area). For instance, the area may be a circle and the user device 104 may determine the distance (e.g., the radius) based on the area of the circle. In other variations, the user device 104 may obtain user input indicating an area for the bounding area. For instance, the user device 104 may display a display screen that the user 102 can use to specify an area (e.g., maximum square mileage to search for a service provider) or features associated with an area (e.g., a county or city). Based on the fixed area and/or the user input indicating the area as well as the geographic location associated with the user 102, the user device 104 may determine a distance (e.g., a radius) that is used to determine the service providers as described below.

FIGS. 5A and 5B will be used to describe block 304 in more detail. For example, referring back to FIG. 5A, the geographic location associated with the user 102 may be the location 502. As shown, multiple service providers 504-508 are included in the area 500. FIG. 5B shows a close-up of certain regions within the area 500. For instance, FIG. 5B shows a close-up version 510 of the area 500 shown in FIG. 5A with the geohashing identifiers “dnr5,” “dnr7,” “dnre,” “dnr4,” “dnr6,” “dnrd,” “dnr1,” “dnr3,” and “dnr9.” After obtaining the geographic location 502 of the user 102, the user device 104 may determine a plurality of boundary points such as boundary points 512A-512D. For instance, based on the fixed distance or user input indicating a distance, the user device 104 may determine the boundary points 512A-512D. For example, the distance may indicate five miles. The user device 104 may determine boundary points that are five miles in the x-direction and five miles in the y-direction away from the geographic location 502. For instance, the user device 104 may determine the boundary point 512A as five miles north and five miles west of the geographic location 502. Similarly, the user device 104 may determine the boundary point 512B as five miles east and five miles north of the geographic location 502, and may do the same for boundary points 512C and 512D. Therefore, the distance between each of the adjacent boundary points may be two times the indicated distance (e.g., the fixed or user input distance). For example, the distance between 512A to 512B may be ten miles. Then, based on the boundary points, the user device 104 may determine the bounding area (e.g., the area 514 defined by the determined boundary points 512A-512D).

In some variations, the user device 104 may determine the plurality of boundary points based on the bounding area. For instance, based on a fixed bounding area or a bounding area indicated by user input, the user device 104 may determine the boundary points (e.g., the corner points of the bounding area).

At block 306, the user device 104 determines, based on the plurality of boundary points, a plurality of geohash strings for the plurality of boundary points. For example, as mentioned previously, each location (e.g., latitude and longitude coordinate) may be associated with a geohash string with a plurality of characters (e.g., text or numerical values). The longer the geohash string, the more precise the location (e.g., the less area the region may encompass). The user device 104 may determine geohash strings for each of the boundary points. For instance, referring to FIG. 5B, each boundary point 512A-512D may be associated with a particular geohash string. For example, the boundary point 512A is within the geohash string “dnr4,” the boundary point 512B is associated with geohash string “dnr6,” the boundary point 512C is associated with geohash string “dnr1,” and the boundary point 512D is associated with geohash string “dnr3.”

At block 308, the user device 104 determines one or more service providers based on the plurality of geohash strings. For example, the user device 104 may perform a search to determine the service providers that are close to the user 102. In some instances, the enterprise computing system 110 or another computing system (e.g., the service provider 108 or another entity such as a computing platform or one or more servers) may include a list of a plurality of service providers and/or locations of the service providers. The user device 104 may use criteria such as geohash strings, a predetermined or specified number of service providers, the bounding area, and/or a common geohash identifier to narrow down the list of service providers so as to determine the closest service provider(s) to the geographic location of the user 102.

In some examples, the user device 104 may use a common geohash identifier to determine the one or more service providers. For example, by comparing the geohash strings of the boundary points (e.g., boundary pointes 512A-512D), the user device 104 determines a common geohash identifier. For instance, the common geohash identifier may be a portion of the geohash string that is present within each of the geohash strings for the boundary points. For example, based on the boundary points 512A-512D, the user device 104 may determine the common geohash identifier as “dnr” because “dnr” is present within each of the geohash strings for the boundary points 512A-512D.

The user device 104 may determine the one or more service providers using the common geohash identifier. For example, the user device 104 may perform a search and determine the service providers that are within the common geohash identifier (e.g., “dnr”). For instance, in some variations, using the plurality of geohash strings and/or the common geohash identifier as the search criteria, the user device 104 may determine the service providers. For instance, the user device 104 may determine the service providers that are located within and/or associated with the common geohash identifier. For example, referring to FIG. 5B, the user device 104 may perform a search using the common geohash identifier (“dnr”) to determine the service providers 504, 505, 506, 508.

Then, in some instances, the user device 104 may filter out (e.g., remove) the search results using the bounding area indicated at block 304 and/or a distance from the geographic location 502 to determine the one or more service providers that are closest to the user 102. For instance, the user device 104 may filter out a service provider such as the service provider 508 that is outside of the bounding area determined at block 304 (e.g., the bounding area 514). For example, after determining the service providers within the common geohash identifier (e.g., “dnr”), the user device 104 may filter the search results using the bounding area (e.g., the bounding area 514 shown in FIG. 5C) and/or the indicated distance (e.g., the fixed or user input distance from block 304) to determine the one or more search providers. For example, referring to FIG. 5C, the user device 104 may first filter the search results using the bounding area 514 to determine the service providers 504, 506, and 505. Then, the user device 104 may filter the remaining search results using the indicated distance (e.g., the circle 522) to determine the service providers 504 and 506. In some instances, the user device 104 may filter the search results solely to bounding area 514 or the indicated distance. In some variations, the user device 104 may filter the search results using the bounding area 514 and the indicated distance in parallel (e.g., at the same time) or in sequence (e.g., one after another).

In other words, the user device 104 may filter out service providers using a distance (e.g., a fixed distance or a user input distance) and/or the bounding area. For example, the distance (e.g., fixed or user input) may be five miles. However, as the boundary points are five miles both in x-axis and y-axis (e.g., boundary point 512A is five miles north and five miles west of the geographic location 502), the user device 104 may filter out service providers that are outside of the indicated distances. For example, service provider 505 is outside of the radius of five miles, but still within the bounding area 514. The user device 104 may use the distances (e.g., a radius such as a radius of five miles) to filter out service providers that are outside of the radius. In some examples, the user device 104 may determine distances (e.g., service provider distances) between the geographic location 502 and each of the service providers (e.g., the service providers 504, 506, 505, and/or 508). Then, the user device 104 may compare the determined distances (e.g., the service provider distances) with the fixed or user input distance (e.g., radius) from block 304. The service providers within the distance/radius is indicated by the circle 522. The user device 104 may filter out the service providers that have determined distances that exceed the fixed or user input distance (e.g., the service providers 505 and/or 508). In some variations, the user device 104 may perform the filtering step using the bounding area and the distance sequentially and/or in parallel (e.g., at the same time). For example, the user device 104 may first filter the service providers using the bounding area, and then filter the remaining service providers using the distances indicated from block 304. Additionally, and/or alternatively, the user device 104 may filter the service providers using the bounding area and using the distances in parallel. In other variations, the user device 104 may filter the search results using solely the bounding area or using solely the distance. For instance, the user device 104 may filter the service providers using the distance or radius indicated by block 304.

In some examples, the user device 104 may determine service providers within the bounding area that are not associated with one or more of the geohash strings from the boundary points. For example, referring to FIG. 5C, if bounding area 514 were so large that it completely enveloped an entire geohash identifier of FIGS. 5A-5C (e.g., completely surrounded “dnr6”), the user device 104 may use a common geohash identifier (“dnr”) to determine service providers within the enveloped geohash identifier (e.g., “dnr6”). Accordingly, using the common geohash identifier, the user device 104 may determine service providers that are not associated with any of the geohash strings of the boundary points.

In some instances, the user device 104 may receive user input indicating particular goods and/or services desired by the user 102 and/or other search criteria. The user device 104 may perform the search and/or filter the search results using the user input. For instance, referring to FIG. 5C, the user input may indicate a skilled nursing facility, but service provider 504 might not be a skilled nursing facility. Accordingly, the user device 104 might not return a search result of service provider 504, but may include the service provider 506.

Additionally, and/or alternatively, the user device 104 may use a predetermined or fixed number of service providers to filter out the service providers. For instance, the user device 104 may retrieve a predetermined number of service providers from memory and use the distance to filter the service providers (e.g., the five closest service providers). In other examples, the user device 104 may obtain user input indicating a number of service providers and/or distance for filtering the service providers. For instance, the user device 104 may display a display screen that the user 102 may use to specify a number of service providers and any desired conditions (e.g., five closest service providers, ten most relevant based on services and goods offered) in addition or in the alternative to specifying a distance or the user device 104 retrieving a distance from memory. The user device 104 may then use the number of service providers and/or a distance to filter the results of the service providers within the bounding area, or use the number of service providers to determine a distance, which may then be used to determine the bounding area (e.g., forming a bounding area with a length equal to the distance of the farthest service provider).

At block 310, the user device 104 causes display of the one or more service providers. For instance, after determining the service providers at block 308, the user device 104 may display on a display device associated with the user device 104 the one or more service providers. In some examples, the user device 104 may display only the closest service provider (e.g., service provider 504 from FIG. 5C) on the display device. In other examples, the user device 104 may display all service providers that remain after the filtering (e.g., the service providers 504 and 506 that are within the circle 522). In some instances, the user device 104 may include the display device (e.g., the user device 104 may be a smartphone with a display). In other instances, the user device 104 may be connected to (e.g., wired, wirelessly, or via the network 106) the display device.

For example, as shown in FIG. 5C, the user device 104 may display a display screen indicating the geographic locations of the one or more service providers, the geographic region indicated by the bounding area 514, and/or the geographic region indicated by the circle 522.

In some variations, another device or system may perform the process 300. For example, the user device 104 may provide a request to another device such as the enterprise computing system 110. The enterprise computing system 110 may perform process 300 and determine the one or more service providers (e.g., service providers 504 and/or 506). The enterprise computing system 110 may provide the results to the user device 104, and the user device 104 may display the results on a display.

In some instances, process 300 may be included within a software application associated with the enterprise organization. For instance, the user device 104 may download a software application from the enterprise computing system 110. When executing the software application, the user device 104 may perform process 300 and display the identified service providers.

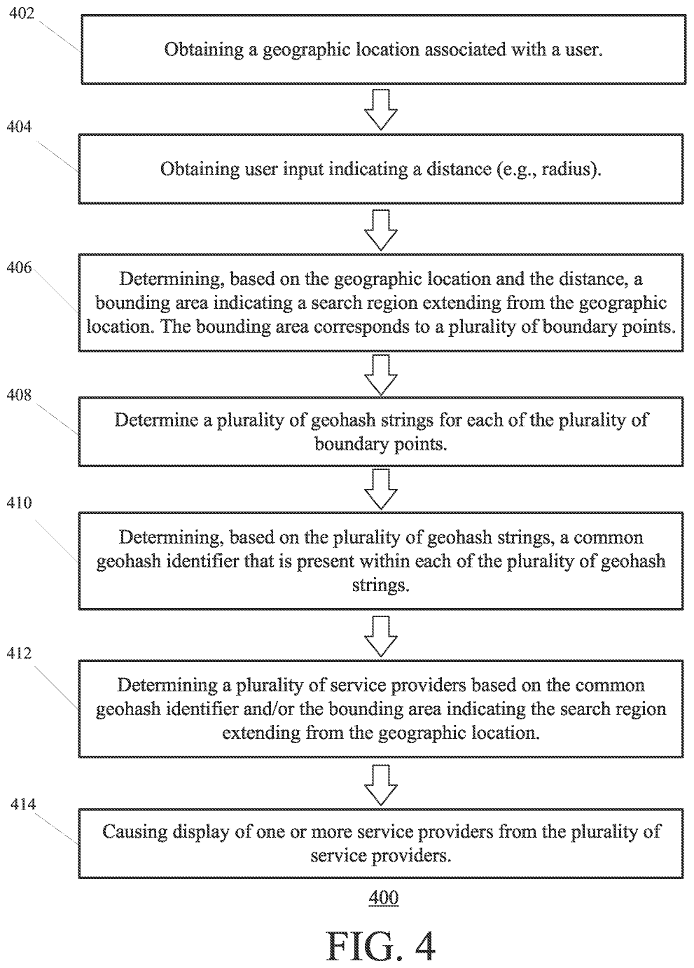

FIG. 4 shows another exemplary process 400 for using bounding box geohashing for locating service providers in accordance with one or more examples of the present application. It will be recognized that any of the blocks of process 400 may be performed in any suitable order, and that the process 400 may be performed in any suitable environment and by any suitable device. For instance, the enterprise computing system 110 may perform the process 400 based on a request from the user device 104. The descriptions, illustrations, and processes of FIG. 4 are merely exemplary and the process 400 may use other descriptions, illustrations, and processes for using bounding box geohashing for locating service providers.

At block 402, the user device 104 obtains a geographic location associated with the user 102. For example, as explained above with respect to the process 300, the user device 104 may obtain the geographic location in many ways, such as through user input from user 102, determining the geographic location using GPS, and receiving a reference location indicating the geographic location from the enterprise computing system 110.

At block 404, the user device 104 obtains a user input indicating a distance (e.g., a radius). For instance, as explained above, the user device 104 may use the distance to determine a geographic region to search with a bounding area. The user input indicating the distance may be the result of the user entering or providing a distance (e.g., five or ten miles, five or ten kilometers) and/or a distance qualifier (e.g., maximum, minimum, average).

At block 406, the user device 104 determines, based on the geographic location (e.g., the geographic location from block 402) and the distance (e.g., the distance from block 404), a bounding area. The bounding area corresponds to a plurality of boundary points (e.g., boundary points 512A-512D of FIG. 5C).

At block 408, the user device 104 determines a plurality of geohash strings for each of the plurality of boundary points of block 406. For example, as explained with reference to FIGS. 5A-5C, the boundary points 512A-512D may form the extent of the bounding area 514. The user device 104 may obtain boundary points 512A-512D in a non-geohash form, such as latitude and longitude, and the user device 104 may then use these to identify and/or determine the geohash strings (e.g., the geohash strings of the boundary points 512A-512D). For example, because 512A lies within “dnr4,” the user device 104 may determine the boundary point 512A of the bounding area 514 as having the geohash string “dnr4.”

At block 410, the user device 104 determines, based on the plurality of geohash strings (e.g., the geohash strings from block 408), a common geohash identifier that is present within each of the plurality of geohash strings. For instance, based on the boundary points 512A-512D, the user device 104 may determine the common geohash identifier as “dnr” because “dnr” is present within each of the geohash strings determined at block 408 for the boundary points 512A-512D.

At block 412, the user device 104 determines a plurality of service providers based on the common geohash identifier and/or the bounding area indicating the search region extending from the geographic location. For example, the user device 104 may identify a plurality of service providers within the common geohash identifier and/or the bounding area. In some instances, the user device 104 may determine the plurality of service providers based on a distance from the user 102, the common geohash identifier, or the bounding area (e.g., bounding area 514).

At block 414, the user device 104 causes display one or more service providers from the plurality of service providers. The one or more service providers may be from a set of the plurality of service providers determined at block 412. The user device 104 may include a display device to display the one or more service providers or the user device 104 may be connected to another device that is configured to display the one or more service providers.

As shown in Table 2, examples of the technology described herein may be faster and more accurate than the conventional or traditional approaches of Table 1. For example, a conventional approach was used, and the results are shown by Table 1. Table 2 shows the results using the bounding box geosearching of the present application (e.g., the process 300 and/or 400 shown in FIGS. 3 and 4 and described above). For instance, as a comparison, Table 2 (e.g., by using process 300 and/or 400) shows a drastically reduced average total time, minimum total time, and maximum total time for the searching of the service providers as compared to the conventional method used for Table 1. Furthermore, Table 2 shows that the success rate in this time period is 100% whereas the conventional approach had a 0% success rate.

TABLE 1

| | Average | Minimum | Max of | Success |
|---|---|---|---|---|
| | of Total | Total | Total | Rate in |
| Method | Time | Time | Time | this Time |
| Traditional | 0:15:14 | 0:10:22 | 0:24:58 | 0% |

TABLE 2

| | Average | Minimum | Max of | Success |
|---|---|---|---|---|
| | of Total | Total | Total | Rate in |
| Method | Time | Time | Time | this Time |
| Inventive | 0:02:46 | 0:00:42 | 0:08:11 | 100% |

In some instances, the bounding box geosearching of the present application (e.g., the process 300 and/or 400 shown in FIGS. 3 and 4 and described above) may be used for network adequacy metrics (e.g., determining the number of participating (PAR) providers within a certain mileage of a user's location or determining a percentage of users that have at least “n” number of providers within a certain mileage).

A number of implementations have been described. Nevertheless, it will be understood that additional modifications may be made without departing from the scope of the inventive concepts described herein, and, accordingly, other examples are within the scope of the following claims. For example, it will be appreciated that the examples of the application described herein are merely exemplary. Variations of these examples may become apparent to those of ordinary skill in the art upon reading the foregoing description. The inventor expects skilled artisans to employ such variations as appropriate, and the inventor intends for the application to be practiced otherwise than as specifically described herein. Accordingly, this application includes all modifications and equivalents of the subject matter recited in the claims appended hereto as permitted by applicable law. Moreover, any combination of the above-described elements in all possible variations thereof is encompassed by the application unless otherwise indicated herein or otherwise clearly contradicted by context.

It will further be appreciated by those of skill in the art that the execution of the various machine-implemented processes and steps described herein may occur via the computerized execution of processor-executable instructions stored on a non-transitory computer-readable medium (e.g., random access memory (RAM), read-only memory (ROM), programmable read-only memory (PROM), volatile, nonvolatile, or other electronic memory mechanism). Thus, for example, the operations described herein as being performed by computing devices and/or components thereof may be carried out by according to processor-executable instructions and/or installed applications corresponding to software, firmware, and/or computer hardware.

The use of the term “at least one” followed by a list of one or more items (for example, “at least one of A and B”) is to be construed to mean one item selected from the listed items (A or B) or any combination of two or more of the listed items (A and B), unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the application and does not pose a limitation on the scope of the application unless otherwise claimed. No language in the specification should be construed as indicating any non-claimed element as essential to the practice of the application.

1. A method for identifying one or more service providers, comprising:
obtaining, by a user device, a geographic location associated with a user;
determining, by the user device and based on the geographic location, a bounding area indicating a search region extending from the geographic location, wherein the bounding area corresponds to a plurality of boundary points;
determining, by the user device and based on the plurality of boundary points, a plurality of geohash strings for the plurality of boundary points;
determining, by the user device, one or more service providers based on the plurality of geohash strings; and
causing, by the user device, display of the one or more service providers.

2. The method of claim 1, wherein obtaining the geographic location comprises:
transmitting, by the user device and to an enterprise computing system, a request for an address of the user; and
receiving, by the user device and from the enterprise computing system, the address of the user, wherein the address indicates the geographic location of the user.

3. The method of claim 1, wherein obtaining the geographic location comprises:
determining, by the user device, latitude and longitude coordinates of the user device using global positioning services (GPS); and
determining the geographic location of the user based on the latitude and longitude coordinates.

4. The method of claim 1, wherein determining the bounding area further comprises:
retrieving, by the user device, a predetermined distance from a memory of the user device; and
determining the bounding area indicating the search region based on the predetermined distance.

5. The method of claim 1, wherein determining the one or more service providers comprises:
determining a plurality of service providers associated with the plurality of geohash strings for the plurality of boundary points; and
filtering the plurality of service providers to determine the one or more service providers based on the bounding area indicated by the search region.

6. The method of claim 1, further comprising:
obtaining, by the user device, a user input indicating a distance for the search region; and
wherein determining the bounding area indicating the search region comprises:
determining the plurality of boundary points based on the distance indicated by the user input, wherein the plurality of boundary points are four corner points of the bounding area.

7. The method of claim 6, wherein determining the one or more service providers comprises:
determining a plurality of service providers associated with the plurality of geohash strings for the plurality of boundary points; and
filtering the plurality of service providers to determine the one or more service providers based on the distance indicated by the user input.

8. The method of claim 7, wherein determining the plurality of service providers associated with the plurality of geohash strings for the plurality of boundary points comprises:
determining, based on the plurality of geohash strings, a common geohash identifier; and
determining the plurality of service providers associated with the common geohash identifier.

9. The method of claim 8, wherein the common geohash identifier and the plurality of geohash strings are bit strings, and the common geohash identifier has fewer bits than each of the plurality of geohash strings.

10. The method of claim 7, wherein filtering the plurality of service providers further comprises:
determining a plurality of service provider distances, wherein each of the plurality of service provider distances indicates a distance between a service provider, from the plurality of service providers, and the geographic location; and
determining the one or more service providers based on comparing the plurality of service provider distances with the distance indicated by the user input.

11. The method of claim 7, further comprising:
determining a circular area associated with the distance indicated by the user input; and
filtering the plurality of service providers to determine the one or more service providers based on the circular area.

12. The method of claim 11, wherein causing display of the one or more service providers comprises causing display of a geographic region indicated by the circular area and geographic locations of the one or more service providers within the circular area.

13. A user device comprising:
one or more processors; and
a non-transitory computer-readable medium having processor-executable instructions stored thereon, wherein the processor-executable instructions, when executed by the one or more processors, facilitate:
obtaining a geographic location associated with a user;
determining, based on the geographic location, a bounding area indicating a search region extending from the geographic location, wherein the bounding area corresponds to a plurality of boundary points;
determining, based on the plurality of boundary points, a plurality of geohash strings for the plurality of boundary points;
determining one or more service providers based on the plurality of geohash strings; and
causing display of the one or more service providers.

14. The user device of claim 13, wherein obtaining the geographic location comprises:
transmitting, to an enterprise computing system, a request for an address of the user; and
receiving, from the enterprise computing system, the address of the user, wherein the address indicates the geographic location of the user.

15. The user device of claim 13, wherein obtaining the geographic location comprises:
determining latitude and longitude coordinates of the user device using GPS; and
determining the geographic location of the user based on the latitude and longitude coordinates.

16. The user device of claim 13, wherein determining the bounding area comprises:
retrieving a predetermined distance from a memory of the user device; and
determining the bounding area indicating the search region based on the predetermined distance.

17. The user device of claim 13, wherein determining the one or more service providers comprises:
determining a plurality of service providers associated with the plurality of geohash strings for the plurality of boundary points; and
filtering the plurality of service providers to determine the one or more service providers based on the bounding area indicated by the search region.

18. The user device of claim 13, wherein the processor-executable instructions, when executed by the one or more processors, further facilitate:
obtaining a user input indicating a distance for the search region, and
wherein determining the bounding area indicating the search region comprises:
determining the plurality of boundary points based on the distance indicated by the user input, wherein the plurality of boundary points are four corner points of the bounding area.

19. The user device of claim 18, wherein determining the one or more service providers comprises:
determining a plurality of service providers associated with the plurality of geohash strings for the plurality of boundary points; and
filtering the plurality of service providers to determine the one or more service providers based on the distance indicated by the user input.

20. A non-transitory computer-readable medium having processor-executable instructions stored thereon, wherein the processor-executable instructions, when executed, facilitate:
obtaining a geographic location associated with a user;
determining, based on the geographic location, a bounding area indicating a search region extending from the geographic location, wherein the bounding area corresponds to a plurality of boundary points;
determining, based on the plurality of boundary points, a plurality of geohash strings for the plurality of boundary points;
determining one or more service providers based on the plurality of geohash strings; and
causing display of the one or more service providers.
